(19) United States
(12) Patent Application Publication
(10) Pub. No.: US 2015/0250196 A1
(43) Pub. Date: Sep. 10, 2015

(54) PROTEIN COMPOSITION FOR USE AS A CHEESE SUBSTITUTE

(71) Applicant: DMK Deutsches Milchkontor GmbH, Zeven (DE)

(72) Inventor: Ralf Zink, Oldenburg (DE)

(21) Appl. No.: 14/636,733

(22) Filed: Mar. 3, 2015

(30) Foreign Application Priority Data
Mar. 4, 2014 (EP) 14 157 728.8

(51) Int. Cl. A23C 20/00

(52) U.S. Cl. CPC A23C 20/00

(57) ABSTRACT

The proposal is for a protein composition intended for use as a cheese substitute and obtainable by
(a) dewatering fermented, sour or acidified milk or corresponding milk products,
(b) adding flavourings and/or colourings and also, optionally, further food additives to the dried composition thus obtained, and
(c) allowing the resulting mixture to swell with water or steam.

### FIELD OF THE INVENTION

The invention is located within the field of foods and relates to a milk-based protein composition that can be offered as a cheese substitute.

### PRIOR ART

Cheese is a solid milk product which with a few exceptions is obtained by coagulation from a protein component of the milk, casein. It is the oldest process for extending the life of milk and milk products. The word “cheese” originates from the Latin “cãseus”, meaning “something fermented, gone sour”, which is also the root for the Spanish “queso” and the New High German “Käse”, via Old High German kāsi and Middle High German kæse.

From 2001 to 2012, the per capita consumption of cheese—taken across all varieties—in Germany went from 21.1 to 23.3 kg. A similar trend can also be shown for the EU, North America, and also Australia and New Zealand—the countries of the world with the longest cheese tradition. Consequently, cheese, in all its multivarious forms, is among the most important and high-volume foodstuffs of all in the western hemisphere.

In the Asian sphere, in contrast, cheese has so far occupied a niche position, despite cheese consumption having increased steadily in recent years in Japan, for example, amounting anyhow to 2.4 kg per head in 2011. The reasons for this are diverse in nature: to start with, there is simply not a culture of cheese in Asia comparable with that in central Europe, for example. The much-touted argument that Asians view cheese as a spoiled milk product and decline to consume it is hardly accurate—especially when it is considered that Asians display much less aversion to fairly unusual foods than is the case in Europe or the USA. An argument with possibly more traction is that Asians show lactose intolerance to a higher degree than central Europeans.

Nevertheless, for companies wishing to market cheese in the Asian sphere, there are high entry barriers, despite the very great potential promised by the market. Consequently, a first component objective underlying the present invention is the matter of how cheese or a cheese-like product can be designed for the Asian market, specifically the market in China, Korea and Japan, such that it will be accepted by the consumer.

Another problem, and hence a further component of the present invention, with which milk and cheese manufacturers in Asia have to deal a is the object of providing flawless-quality products with a long shelf life without detriment to their enjoyment qualities, whilst also being actually ready for consumption within a very short time.

The object of the present invention was therefore that of uniting the two component objectives outlined above, and providing a full solution to the overall problem.

### DESCRIPTION OF THE INVENTION

A subject of the invention is a protein composition for use as cheese substitute, obtainable by
(a) dewatering fermented, sour or acidified milk or corresponding milk products,
(b) adding flavourings and/or colourings and also, optionally, further food additives to the dried composition thus obtained, and
(c) allowing the resulting mixture to swell with water or steam.

A further subject of the invention relates to a process for producing a protein composition with cheese texture, by
(a) dewatering fermented, sour or acidified milk or corresponding milk products,
(b) adding flavourings and/or colourings and also, optionally, further food additives to the dried composition thus obtained, and
(c) allowing the resulting mixture to swell with water or steam,

where the last step takes place at temperatures in the range from 50 to 150° C.

Surprisingly it has been found that the object outlined is achieved in full by the above-outlined combination of steps (a), (b) and (c).

A particular advantage of the present invention is that the protein compositions can be produced in common kitchen appliances, such as a sous-vide cooker, a Thermomix appliance or a pressure cooker, with step (c) taking place at a pressure in the range from 0.1 to 1 bar or from 1 to 5 bar.

### STARTING MATERIALS

Milk is a whitish, opaque solution or colloidal dispersion of proteins, lactose and milk fat in water. It is formed in the milk glands of mammals, who use it to feed their newborns. In the context of the present invention, acidification or fermentation products of milk, or acidification or fermentation products of milk products, are utilized as starting materials.

Soured or Fermented Milk

In a first embodiment of the present invention, soured or fermented milk is contemplated as a starting material. It is produced in general from pasteurized milk, by the addition thereto of bacterial cultures which convert lactose into lactic acid. An alternative possibility is to add enzymes or acids. As a result, the casein is precipitated, leading to an increase in the viscosity (coagulation). Employed preferably here are mesophilic streptococcal cultures, such as Streptococcus lactis or Streptococcus cremoris, for example, which exhibit a temperature optimum in the range from 22 to 28° C. The milk mixture is subsequently coagulated at temperatures of 25 to 28° C. over 15 to 20 hours.

Yoghurt

In a first alternative embodiment, yoghurt too is contemplated as a starting material. Yoghurt is milk thickened bacterially; the product possesses a sharp flavour. Yoghurt production represents a fermentation process: lactic acid bacteria convert lactose into lactic acid, the characteristic flavour and the aroma coming about at the same time. In contrast to the production of soured milk or fermented milk, yoghurt production uses thermophilic cultures, which exhibit an activity optimum at 40 to 44° C. Typical representatives are Streptococcus thermophilus, Lactobacillus bulgaricus, Bifidobacterium and also Lactobacillus Acidophilus, which are used as pure cultures or in mixtures. These bacteria form predominantly dextrorotatary L(+)-lactic acid. This is the physiological form more suitable for humans, and is broken down more rapidly by a specific enzyme, L(+)-lactate dehydrogenase.

The lactic acid causes a lowering in pH. Below a certain pH, the casein micelles are no longer able to stay in solution, and they coagulate, forming a network. The water and remaining protein fractions (whey) present in the milk are enclosed in the interstices. Acidification must be monitored throughout the production procedure; this is done by measuring the pH of the vat milk. Coagulation of the milk begins at pH of around 5.5 and ends, depending on culture, at a pH of down to 3.8. Acidification ought ideally to be ended at a pH of 4.65 (the isoelectric point), since otherwise there is whey syneresis, with contraction of yoghurt at lower pH levels and with deposition of whey.

Kefir

In a further alternative embodiment, kefir as well may serve as a starting material. Kefir (from the Turkish word köpürmek “to foam”) is a milk beverage with a thick consistency that contains carbonic acid and a little alcohol and which comes originally from the northern Caucasus and from Tibet. A fermentation process gives rise to kefir, typically by means of lactic acid bacteria such as Lactococcus lactis and Lactobacillus acidophilus, yeasts such as Kluyveromyces marxianus, and also acetic acid bacteria. Along with chhurpi, kefir is one of the few milk products produced using yeast.

Milk kefir is produced by treating cow's, goat's or sheep's milk for one to two days with kefir grains (a fungus consisting of bacteria, yeasts, proteins, lipids and polysaccharides which are produced by various bacteria among those contained in the grains). Also possible is the use of mare's milk, in which case the product is called kumis; even coconut milk is suitable for the production of kefir. The mixture is then left to stand. Many instructions provide for it to be stirred once after a few hours. Optimum temperatures are between 10° C. and 25° C. In the process, the milk is fermented. Depending on the fermentation time, the alcohol content of the finished product may amount to from 0.2 up to a maximum of around 2 wt %. At relatively low temperatures, yeast fermentation is predominant, and the product contains more carbon dioxide and ethanol and less lactic acid. At higher temperatures, lactic acid fermentation is preferred, and the ethanol content is lower, the lactic acid content higher. Fat content and protein content are roughly in line with that of the milk used. The creamy beverage has a slightly sharp flavour. The kefir is separated, using a sieve and gentle shaking, from the cauliflower-like kefir grains, which are subsequently washed with cold water and can then be used again for the next batch.

Kefir manufactured industrially and offered for sale usually does not match the beverage produced traditionally using kefir grains, and is designated as mild kefir. So that the resulting beverage always has the same flavour, industrial operation takes place using a defined mixture of different bacteria and yeasts, that can never fully mimic the complex composition of the consortium of microorganisms in kefir grains. Traditional kefir has a regional composition which can show seasonal alteration. Mild kefir generally contains no alcohol, but does still contain about 2.7-3.9 g of lactose per 100 g and is therefore unsuitable in cases of lactose intolerance. In contrast, the true kefir contains alcohol, but is lactose-free.

Quark

Quark, also called white cheese, and termed Topfen in Bavarian or Schotten in Austrian, is a fresh cheese likewise contemplated as an alternative starting product for the protein compositions of the invention. Quark in Germany is produced almost exclusively from pasteurized milk. Quark is a soured milk cheese. In contrast to the sweet milk cheeses, coagulation is accomplished not by the addition of rennet, but instead by lactic acid (for example: lactic acid bacteria, cheesemaking acid) or acid (for example: citric acid or acetic acid). Preference for this purpose is given to the addition of lactic acid bacteria to pasteurized skimmed milk. These bacteria convert some of the lactose to lactic acid. With the increase in lactic acid, there is a gradual fall in the pH of the milk. When it falls beneath a particular level, the casein precipitates to give what is called the “coagulum”. This process takes 30 minutes to 2 hours, and the temperatures at coagulation varies between 21 and 35° C. By mechanical means—by allowing the coagulum to drip in a cloth or by centrifuging in the case of industrial production—the coagulum is divided into its solid (here just the coagulated casein) and liquid (the whey together with the whey proteins in solution in the liquid) constituents. The cheese curd is finely sieved, and cream is added according to the desired fat content. Industrially, quark is also produced by means of ultrafiltration or low-temperature acidification.

Acid Whey

Acid whey, also called just whey (additionally cheese whey, milk serum) is a suitable starting material for producing the protein compositions of the invention. It is a watery, greenish yellow residual liquid which is obtained in the production of milk products worldwide in a quantity of around 82 billion tonnes per annum. It consist of 94% water, 4% to 5% lactose, and is virtually fat-free. There are two kinds of whey: sweet whey (also rennet whey), which is formed when milk is coagulated with rennet for cheese production. Acid whey is formed when the milk is treated with lactic acid bacteria. After the protein has been separated off as cheese or Quark, the whey remains, and in general it constitutes a waste product. Besides lactic acid, whey additionally contains vitamins B1, B2 and B6, and also potassium, calcium, phosphorus and other minerals, but in particular up to 1 wt % of whey protein.

### DEWATERING

The milk or milk products which serve as starting materials for the protein compositions of the invention can be freed from water, and thus dried, by the standard methods of the industry, especially of food technology. Requirements are that the methods are gentle and the proteins are not denatured or destroyed. Examples of suitable methods include spray drying, and especially freeze drying (lyophilization). The water can also be removed from the starting materials gently in evaporating apparatus, such as stirring devices, for example, which operate under vacuum, or in rotary evaporators.

The dewatered products may still have a residual moisture content of at most 5 wt %, preferably about 0.5 to about 4 wt % and more particularly from about 1 to about 3 wt %.

### FLAVOURINGS

The selection of the flavourings for admixing to the protein compositions of the invention is not critical and is determined exclusively by the intended use.

Typical examples of flavours include the following: acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidene phthalide, carvone, camphene, caryophyllene, cineol, cinnamyl acetate, citral, citronellol, citronellal, citronellyl acetate, cyclohexyl acetate, cymene, damascone, decalactone, dihydrocoumarin, dimethyl anthranilate, diethyl anthranilate, dodecalactone, ethoxyethyl acetate, ethylbutyric acid, ethyl butyrate, ethyl caprate, ethyl caproate, ethyl crotonate, ethyl furaneol, ethyl guaiacol, ethyl isobutyrate, ethyl isovalerate, ethyl lactate, ethyl methyl butyrate, ethyl propionate, eucalyptol, eugenol, ethyl heptylate, 4-(p-hydroxyphenyl)-2-butanone, gamma-decalactone, geraniol, geranyl acetate, geranyl acetate, grapefruit aldehyde, methyl dihydrojasmonate (e.g. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxybenzylacetone, isoamyl alcohol, isoamyl isovalerate, isobutyl butyrate, isobutyraldehyde, isoeugenol methyl ether, isopropylmethylthiazole, lauric acid, levulinic acid, linalool, linalool oxide, linalyl acetate, menthol, menthofuran, methyl anthranilate, methylbutanol, methylbutyric acid, 2-methylbutyl acetate, methyl caproate, methyl cinnamate, 5-methylfurfural, 3,2,2-methylcyclopentenolone, 6,5,2-methylheptenone, methyl dihydrojasmonate, methyl jasmonate, 2-methylmethyl butyrate, 2-methyl-2-pentenolic acid, methyl thiobutyrate, 3,1-methylthiohexanol, 3-methylthiohexyl acetate, nerol, neryl acetate, trans,trans-2,4-nonadienal, 2,4-nonadienol, 2,6-nonadienol, 2,4-nonadienol, nootkatone, delta octalactone, gamma octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl isovalerate, piperonal, propionaldehyde, propyl butyrate, pulegone, pulegol, sinensal, sulphurol, terpinene, terpineol, terpinols, 8,3-thiomenthanone, 4,4,2-thiomethylpentanone, thymol, delta-undecalactone, gamma-undecalactone, valencene, valeric acid, vanillin, acetoin, ethylvanillin, ethylvanillin isobutyrate (=3-ethoxy-4-isobutyryloxybenzaldehyde), 2,5-dimethyl-4-hydroxy-3(2H)-furanone and derivatives thereof (here preferably homofuraneol (=2-ethyl-4-hydroxy-5-methyl-3(2H)-furanone), homofuronol (=2-ethyl-5-methyl-4-hydroxy-3(2H)-furanone and 5-ethyl-2-methyl-4-hydroxy-3(2H)-furanone), maltol and maltol derivatives (here preferably ethyl maltol), coumarin and coumarin derivatives, gamma-lactones (here preferably gamma-undecalactone, gamma-nonalactone, gamma-decalactone), delta-lactones (here preferably 4-methyl deltadecalactone, massoilactone, deltadecalactone, tuberolactone), methyl sorbate, divanillin, 4-hydroxy-2(or 5)-ethyl-5(or 2)-methyl-3(2H)furanone, 2-hydroxy-3-methyl-2-cyclopentenone, 3-hydroxy-4,5-dimethyl-2(5H)-furanone, acetic acid isoamyl ester, butyric acid ethyl ester, butyric acid-n-butyl ester, butyric acid isoamyl ester, 3-methyl-butyric acid ethyl ester, n-hexanoic acid ethyl ester, n-hexanoic acid allyl ester, n-hexanoic acid-n-butyl ester, n-octanoic acid ethyl ester, ethyl -3-methyl-3-phenylglycidate, ethyl -2-trans-4-cis-decadienoate, 4-(p-hydroxyphenyl)-2-butanone, 1,1-dimethoxy-2,2,5-trimethyl-4-hexane, 2,6-dimethyl-5-hepten-1-a1 and phenylacetaldehyde, 2-methyl-3-(methylthio)furan, 2-methyl-3-furanthiol, bis(2-methyl-3-furyl) disulphide, furfuryl mercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3(2H)-furanone, guaiacol, 3-hydroxy-4,5-dimethyl-2(5H)-furanone, 3-hydroxy-4-methyl-5-ethyl-2(5H)-furanone, cinnamaldehyde, cinnamyl alcohol, methyl salicylate, isopulegol and (not explicitly stated here) stereoisomers, enantiomers, positional isomers, diastereomers, cis/trans isomers or epimers of these substances.

Particularly preferred flavours are those with a marine-animal or seaweed-like aura, such as alkylpyridines, for example. These endow the protein compositions with a “sushi taste”, which is highly prized especially in Asian latitudes.

### COLOURINGS

Food colourings, or colourings for short, are food additives for colouring foodstuffs. Their selection is likewise uncritical in the present case, and is guided by the intended end use. Colourings are subdivided into the groups of the natural colours and synthetic colours. The nature-identical colourings are likewise of synthetic origin. The nature-identical colourings are synthetic copies of colouring substances that occur in nature. Suitable colourings for use in the present composition are selected from the following: curcumin, E 100 riboflavin, lactoflavin, vitamin B2, E 101 tartrazine, E 102 quinoline yellow, E 104 yellow-orange S, yellow-orange RGL, E 110 cochineal, carminic acid, true carmine, E 120 azorubine, carmoisin, E 122 amaranth, E 123 cochineal red A, Ponceau 4 R, Victoria scarlet 4 R, E 124 erythrosine, E 127 Allura red AC, E 129 Patent blue V, E 131 indigotin, indigo carmine, E 132 Brilliant Blue FCF, Patent Blue AE, Amido Blue AE, E 133 chlorophylls, chlorophyllins, E 140 copper complexes of chlorophylls, copper-chlorophyllin complex, E 141 Brilliant Acid Green, Green S, E 142 caramel colour, E 150 a sulphite lye caramel colour, E 150 b ammonia caramel colour, E 150 c ammonium sulphite caramel colour, E 150 d Brilliant Black FCF, Brilliant Black PN, Black PN, E 151 vegetable charcoal, E 153 Brown FK, E 154 Brown HT, E 155 carotene, E 160 a annatto, bixin, norbixin, E 160 b capsanthin, capsorubin, E 160 c lycopene, E 160 d beta-apo-8′-carotenal, apocarotenal, beta-apocarotenal, E 160 e beta-apo-8′-carotenoic acid ethyl ester (C30), apocarotene esters, beta-carotenoic esters, E 160 f lutein, xanthophyll, E 161 b canthaxanthin, E 161 g betanin, beet red, E 162 anthocyans, E 163 calcium carbonate, E 170 titanium dioxide, E 171 iron oxides, iron hydroxides, E 172 aluminium, E 173 silver, E 174 gold, E 175 lithol rubine BK, rubine pigment BK, E 180.

### FURTHER FOOD ADDITIVES

The protein composition of the invention may have further ingredients as well as the flavourings and colourings, such as, for example, sweeteners, food acids, acid regulators, thickeners, prebiotics, probiotics, flavour enhancers, flavour-masking agents, antioxidants and the like.

Sweeteners

As sweeteners or sweet-tasting additives, firstly carbohydrates and especially sugars may come into consideration, such as sucrose, trehalose, lactose, maltose, melezitose, raffinose, Palatinose, lactulose, D-fructose, D-glucose, D-galactose, L-rhamnose, D-sorbose, D-mannose, D-tagatose, D-arabinose, L-arabinose, D-ribose, D-glycerol aldehyde, or maltodextrin. Vegetable preparations that contain these substances are also suitable, for example based on sugar beet (Beta vulgaris ssp., sugar fractions, sugar syrup, molasses), sugar cane (Saccharum officinarum ssp., molasses, sugar cane syrup), maple syrup (Acer ssp.) or agave (agave nectar).

Consideration may also be given to synthetic, i.e. as a rule enzymatically produced starch or sugar hydrolysates (invert sugar, fructose syrup);

fruit concentrates (e.g. based on apples or pears);

sugar alcohols (e.g. erythritol, threitol, arabitol, ribitol, xylitol, sorbitol, mannitol, dulcitol, lactitol);

proteins (e.g. miraculin, monellin, thaumatin, curculin, brazzein);

sweeteners (e.g. Magap, sodium cyclamate, acesulfame K, neohesperidin dihydrochalcone, saccharin sodium salt, aspartame, superaspartame, neotame, alitame, sucralose, steviosides, rebaudiosides, lugduname, carrelame, sucrononate, sucrooctate, monatin, phenylodulcin);

sweet-tasting amino acids (e.g. glycine, D-leucine, D-threonine, D-asparagine, D-phenylalanine, D-tryptophan, L-proline);

other sweet-tasting low-molecular substances, e.g. hernandulcin, dihydrochalcone glycosides, glycyrrhizin, glycyrrhetic acid, derivatives and salts thereof, extracts of liquorice (Glycyrrhizza glabra ssp.), Lippia dulcis extracts, Momordica ssp. extracts or

individual substances, e.g. Momordica grosvenori [Luo Han Guo] and the mogrosides obtained therefrom, Hydrangea dulcis or Stevia ssp. (e.g. Stevia rebaudiana) extracts.

Food Acids

The foods may contain carboxylic acids. Acids in the sense of the invention are preferably acids permitted in foodstuffs, especially those stated here:
E 260—acetic acid
E 270—lactic acid
E 290—carbon dioxide
E 296—malic acid
E 297—fumaric acid
E 330—citric acid
E 331—sodium citrate
E 332—potassium citrate
E 333—calcium citrate
E 334—tartaric acid
E 335—sodium tartrate
E 336—potassium tartrate
E 337—sodium-potassium tartrate
E 338—phosphoric acid
E 353—metatartaric acid
E 354—calcium tartrate
E 355—adipic acid
E 363—succinic acid
E 380—triammonium citrate
E 513—sulphuric acid
E 574—gluconic acid
E 575—glucono-delta-lactone

Acidity Regulators

Acid regulators are food additives that keep the acidity or basicity and thus the desired pH of a foodstuff constant. They are generally organic acids and salts thereof, carbonates, less often also inorganic acids and salts thereof. Addition of an acid regulator partly intensifies the stability and strength of the foodstuff, brings about desirable precipitation and improves the action of preservatives. In contrast to acidifiers , they are not used for altering the taste of foodstuffs. Their action is based on the formation of a buffer system in the foodstuff, so that addition of acidic or basic substances has little or no effect on the pH. Examples are:
E 170—calcium carbonate
E 260-263—acetic acid and acetates
E 270—lactic acid
E 296—malic acid
E 297—fumaric acid
E 325-327—lactates (lactic acid)
E 330-333—citric acid and citrates
E 334-337—tartaric acid and tartrates
E 339-341—orthophosphates
E 350-352—malates (malic acid)
E 450-452—di-, tri- and polyphosphates
E 500-504—carbonates (carbonic acid)
E 507—hydrochloric acid and chlorides
E 513-517—sulphuric acid and sulphates
E 524-528—hydroxides
E 529-530—oxides
E 355-357—adipic acid and adipates
E 574-578—gluconic acid and gluconates

Thickeners

Thickeners are substances which first and foremost are able to bind water. Removal of unbound water leads to an increase in viscosity. Starting from a characteristic concentration for each thickener, in addition to this effect there are also network effects, which lead to a generally disproportionate increase in viscosity. It is said in this case that molecules ‘communicate’, i.e. “form loops” with one another. Most thickeners are linear or branched macromolecules (e.g. polysaccharides or proteins), which can interact with one another through intermolecular interactions, such as hydrogen bonds, hydrophobic interactions or ionic relationships. Extreme cases of thickeners are sheet silicates (bentonites, hectorites) or hydrated SiO₂ particles , which are present dispersed as particles and can bind water in their solid-like structure or can interact with one another owing to the interactions described. Examples are:
E 400—alginic acid
E 401—sodium alginate
E 402—potassium alginate
E 403—ammonium alginate
E 404—calcium alginate
E 405—propylene glycol alginate
E 406—agar-agar
E 407—carrageen, furcelleran
E 407—carob kernel flour
E 412—guar kernel flour
E 413—tragacanth
E 414—gum arabic
E 415—xanthan
E 416—karaya (Indian tragacanth)
E 417—tara kernel flour (Peruvian carob kernel flour)
E 418—gellan
E 440—pectin, opecta
E 440ii—amidated pectin
E 460—microcrystalline cellulose, cellulose powder
E 461—methylcellulose
E 462—ethylcellulose
E 463—hydroxypropylcellulose
E 465—methylethylcellulose
E 466—carboxymethylcellulose, sodium carboxymethylcellulose

Vitamins

In another embodiment of the present invention, the protein compositions may contain vitamins, as another optional group of additives. Vitamins have exceedingly varied mechanisms of biochemical action. Some act similarly to hormones and regulate the metabolism of minerals (e.g. vitamin D), or act on the growth of cells and tissue and on cellular differentiation (e.g. some forms of vitamin A). Others are antioxidants (e.g. vitamin E and under certain circumstances also vitamin C). The largest number of vitamins (e.g. the B vitamins) are precursors of enzyme co-factors, which support enzymes in the catalysis of certain metabolic processes. In this connection, vitamins may sometimes be tightly bound to the enzymes, for example as part of the prosthetic group: an example of this is biotin, which is a part of the enzyme that is responsible for the synthesis of fatty acids. Vitamins may on the other hand also be bound less strongly and then act as co-catalysts, for example as groups that can easily be split off, and transport chemical groups or electrons between the molecules. Thus, for example, folic acid transports methyl, formyl and methylene groups into the cell. Although their support in enzyme-substrate reactions is well known, their other properties are also of great importance for the body.

In the context of the present invention, substances contemplated as vitamins include those selected from the group consisting of

vitamin A (retinol, retinal, beta-carotene),

vitamin B₁ (thiamine),

vitamin B₂ (riboflavin),

vitamin B₃ (niacin, nicotinamide),

vitamin B₅ (pantothenic acid),

vitamin B₆ (pyridoxine, pyridoxamine, pyridoxal),

vitamin B₇ (biotin),

vitamin B₉ (folic acid, folinic acid),

vitamin B₁₂ (cyanocobalamin, hydroxocobalamin, methylcobalamin),

vitamin C (ascorbic acid),

vitamin D (cholecalciferol),

vitamin E (tocopherols, tocotrienols) and

vitamin K (phylloquinone, menaquinone).

The preferred vitamins are, in addition to ascorbic acid, the tocopherols group.

Prebiotic Substances

In another embodiment of the invention, the protein compositions may further contain prebiotic substances (prebiotics), which form group H. Prebiotics are defined as indigestible food constituents whose ingestion stimulates the growth or the activity of a number of useful bacteria in the colon. Addition of prebiotic compounds improves the stability of anthocyanins against degradation processes in the intestinal tract. Various substances, especially carbohydrates, that are especially preferred as prebiotics in the sense of the invention are presented below.

Fructo- and glucooligosaccharides. Fructooligosaccharides and glucooligosaccharides, or FOS and GOS for short, respectively, comprise—in particular—short-chain representatives with 3 to 5 carbon atoms, for example D-fructose and D-glucose. FOS, also called neosugars, are produced commercially on the basis of sucrose and the enzyme fructosyl transferase obtained from fungi. FOS support in particular the growth of bifidobacteria in the gut and are marketed, mainly in the USA, together with probiotic bacteria in various functional foodstuffs.

Inulins. Inulins belong to a group of naturally occurring fructose-containing oligosaccharides. They belong to a class of carbohydrates called fructans. They are obtained from the roots of the chicory plant (Cichorium intybus) or so-called Jerusalem artichokes. Inulins consist mainly of fructose units and typically have a glucose unit as end group. The fructose units are linked together via a beta-(2-1)glycosidic bond. The average degree of polymerization of inulins that find application as prebiotics in the food industry is 10 to 12. Inulins also stimulate the growth of bifidobacteria in the colon.

Isomaltooligosaccharides. This group is a mixture of alpha-D-linked glucose oligomers, including isomaltose, panose, isomaltotetraose, isomaltopentaose, nigerose, kojibiose, isopanose and higher branched oligosaccharides. Isomaltooligosaccharides are produced by various enzymatic routes. They also stimulate the growth of bifidobacteria and lactobacilli in the colon. Isomaltooligosaccharides are used especially in Japan as food additives in functional foodstuffs. They are now also being used more widely in the USA.

Lactilol. Lactilol is the disaccharide of lactulose. It is used medically against constipation and in hepatic encephalopathy. Lactilol is used as a prebiotic in Japan. It resists breakdown in the upper digestive tract, but is fermented by various intestinal bacteria, which leads to an increase in the biomass of bifidobacteria and lactobacilli in the gut. Lactilol is also known by the chemical name 4-O-(beta-D-galactopyranosyl)-D-glucitol. The medical applications of lactilol in the USA are limited owing to lack of research; in Europe it is used preferably as a sweetener.

Lactosucrose. Lactosucrose is a trisaccharide that is made up of D-galactose,

D-glucose and D-fructose. Lactosucrose is produced by enzymatic transfer of the galactosyl residue in lactose to sucrose. It is not broken down in the stomach or in the upper part of the intestinal tract and is consumed exclusively by bifidobacteria for growth. From the physiological standpoint, lactosucrose acts as a stimulator of the growth of the intestinal flora. Lactosucrose is also known as 4G-beta-D-galactosucrose. It is widely used in Japan as a food additive and as a constituent of functional foods, in particular also as an additive for yoghurts. Lactosucrose is currently also being tested in the USA for similar applications.

Lactulose. Lactulose is a semi-synthetic disaccharide composed of D-lactose and D-fructose. The sugars are linked via a beta-glycosidic bond, which makes them resistant to hydrolysis by digestive enzymes. Instead, lactulose is fermented by a limited number of gut bacteria, which leads to growth especially of lactobacilli and bifidobacteria. In the USA, lactulose is a prescription medicine against constipation and hepatic encephalopathy. In Japan, however, it is sold freely as a food additive and constituent of functional foods.

Pyrodextrins. Pyrodextrins comprise a mixture of glucose-containing oligosaccharides, which are formed in the hydrolysis of starch. Pyrodextrins promote the proliferation of bifidobacteria in the colon. They too are not broken down in the upper part of the intestine.

Soya oligosaccharides. This is a group of oligosaccharides that occur essentially only in soya beans and additionally in other beans and peas. The two main representatives are the trisaccharide raffinose and the tetrasaccharide stachyose. Raffinose is composed of one molecule each of D-galactose, D-glucose and D-fructose. Stachyose consists of two molecules of D-galactose and one molecule each of D-glucose and D-fructose. Soya oligosaccharides stimulate the growth of bifidobacteria in the colon and are already used in Japan as food additives and in functional foods. They are currently being tested in the USA for this application.

Transgalactooligosaccharides. Transgalactooligosaccharides (TOS) are mixtures of oligosaccharides based on D-glucose and D-galactose. TOS are produced starting from D-lactose with the aid of the enzyme betaglucosidase from Aspergillus oryzae. Like many other prebiotics, TOS are also stable in the small intestine and stimulate the growth of bifidobacteria in the colon. TOS are already marketed as food additives both in Europe and in Japan.

Xylooligosaccharides. Xylooligosaccharides contain beta-1,4-linked xylose units. The degree of polymerization of the xylooligosaccharides is between 2 and 4. They are obtained by enzymatic hydrolysis of the polysaccharide xylan. They are already marketed as food additives in Japan; in the USA they are still at the phase of testing.

Biopolymers. Suitable biopolymers also contemplated as prebiotics, for example beta-glucans, are notable in that they are produced on a plant basis; for example, possible raw materials are cereals such as oats and barley, but also fungi, yeasts and bacteria. Microbially produced cell wall suspensions or whole cells with high beta-glucan content are also suitable. Residual fractions of monomers have 1-3 and 1-4 or 1-3 and 1-6 linkages, and the content may vary widely. Preferably, beta-glucans are obtained on the basis of yeasts, especially Saccharomyces, in particular Saccharomyces cerevisiae. Other suitable biopolymers are chitin and chitin derivatives, especially oligoglucosamine and chitosan, which is a typical hydrocolloid.

Galactooligosaccharides (GOS). Galactooligosaccharides are produced by the enzymatic transformation of lactose, a component of bovine milk. GOS generally comprise a chain of galactose units, which are formed by successive transgalactosylation reactions, and which have a terminal glucose unit. Terminal glucose units are mostly formed by early hydrolysis of GOS. The degree of polymerization of the GOS may fluctuate quite widely and ranges from 2 to 8 monomer units. A range of factors determine the structure and the order of the monomer units: the enzyme source, the starting material (lactose concentration and origin of the lactose), the enzymes participating in the process, conditions during processing, and the composition of the medium.

Probiotic Microorganisms

Probiotic microorganisms, also called probiotics, which form group (N), are live microorganisms which possess properties that are useful for the host. According to the FAO/WHO definition, they are “live microorganisms which at appropriate dosage give the host a health advantage”. Lactic acid bacteria (LAB) and bifidobacteria are the best-known probiotics; however, various yeasts and bacilli may also be used. Probiotics are usually ingested as a constituent of fermented foods to which special live cultures have been added, e.g. yoghurt, soya yoghurt or other probiotic foods. Furthermore, tablets, capsules, powders and sachets are also available, which contain the microorganisms in freeze-dried form. Table A provides a review of commercially available probiotics and the associated health benefits, which may be used in the sense of the present invention as component (b1).

TABLE A
Probiotic substances

| Strain | Name | Manufacturer | Benefit |
|---|---|---|---|
| Bacillus coagulans | GanedenBC | Ganeden Biotech | Increases the immune response |
| GBI-30, 6086 | | | in viral infection |
| Bifidobacterium | Probio-Tec | Chr. Hansen | Clinical studies on humans have |
| animalis subsp. lactis | Bifidobacterium | | shown that BB-12 alone or in |
| BB-12 | BB-12 | | combination has a positive |
| | | | influence on the |
| | | | gastrointestinal system. |
| Bifidobacterium infantis | Align | Procter & Gamble | It was shown in a preliminary |
| 35624 | | | study that the bacterium may |
| | | | reduce abdominal pains. |
| Lactobacillus | | Danisco | A study has shown that the |
| acidophilus NCFM | | | side-effects of antibiotic |
| | | | treatments are reduced. |
| Lactobacillus paracasei | | | |
| St11 (or NCC2461) | | | |
| Lactobacillus johnsonii | | Nestlé | Decrease in gastritis complaints |
| La1 (=Lactobacillus LC1, | | | and reduced inflammation |
| Lactobacillus johnsonii | | | |
| NCC533) | | | |
| Lactobacillus plantarum | Good Belly/ | Probi | Might improve IBS symptoms; |
| 299v | ProViva/ | | however, further studies |
| | ProbiMage | | required. |
| Lactobacillus reuteri | | BioGaia | Initial indication for efficacy |
| American Type Culture | | | against gingivitis, fever in |
| Collection ATTC 55730 | | | children and decrease in days |
| (Lactobacillus reuteri | | | of disease in adults. |
| SD2112) | | | |
| Lactobacillus renteri | | | |
| Protectis (DSM 17938, | | | |
| daughter strain of ATCC | | | |
| 55730) | | | |
| Lactobacillus reuteri | | | |
| Protectis (DSM 17938, | | | |
| daughter strain of ATCC | | | |
| 55730) | | | |
| Saccharomyces | DiarSafe and | Wren Laboratories | Limited proof in the treatment |
| boulardii | others | | of acute diarrhoea diseases. |
| Lactobacillus | Bion Fiore | Chr. Hansen | In one study, proof of efficacy |
| rhamnosus GR-1 & | Intime/Jarrow | | against vaginitis. |
| Lactobacillus reuteri | Fem-Dophilus | | |
| RC-14 | | | |
| Lactobacillus | Florajen3 | American Lifeline, | First indications of efficacy |
| acidophilus NCFM & | | Inc | against CDAD |
| Bifidobacterium bifidum | | | |
| BB-12 | | | |
| Lactobacillus | Bio-K + CL1285 | Bio-K + | Investigations of improvement |
| acidophilus CL1285 & | | International | of digestion, especially with |
| Lactobacillus casei | | | respect to lactose intolerance. |
| LBC80R | | | |
| Lactobacillus plantarum | Bravo | Probi | Studies in progress regarding |
| HEAL 9 & Lactobacillus | Friscus/ProbiFrisk | | efficacy against colds. |
| paracasei 8700: 2 | | | |

Two further forms of lactic acid bacteria that may also be used as probiotics are stated below:
Lactobacillus bulgaricus;
Streptococcus thermophilus;

Special fermented products based on these lactic acid bacteria may also be used:
mixed pickles;
fermented bean paste such as tempeh, miso and doenjang;
kefir;
buttermilk;
kimchi;
pao cai;
soy sauce;
zha cai.

Flavour Enhancers

These protein compositions of the invention may further comprise additional flavourings for intensifying a salty, optionally slightly sour and/or umami taste impression. Therefore the products or flavouring mixtures according to the invention are used in combination with at least one further substance suitable for intensifying a pleasant perceived taste (salty, umami, optionally slightly sour). Salty tasting compounds and salt-intensifying compounds are preferred. Preferred compounds are disclosed in WO 2007/045566. Umami compounds as described in WO 2008/046895 and EP 1 989 944 are further preferred.

Active Ingredients to Mask Unpleasant Perceived Tastes

Furthermore, the protein compositions may also comprise other substances that serve likewise for masking bitter and/or astringent taste perceptions. The further flavour correctants are selected for example from the following list: nucleotides (e.g. adenosine-5′-monophosphate, cytidine-5′-monophosphate) or physiologically acceptable salts thereof, lactisols, sodium salts (e.g. sodium chloride, sodium lactate, sodium citrate, sodium acetate, sodium gluconate), hydroxyflavanones, here preferably eriodictyol, sterubin (eriodictyol-7-methyl ether), homoeriodictyol, and sodium, potassium, calcium, magnesium or zinc salts thereof (especially as described in EP 1258200 A2, which with respect to the corresponding compounds disclosed therein forms part of this application by reference), hydroxybenzoic acid amides, here preferably 2,4-dihydroxybenzoic acid vanillyl amide, 2,4-dihydroxybenzoic acid-N-(4-hydroxy-3-methoxybenzyl)amide, 2,4,6-trihydroxybenzoic acid-N-(4-hydroxy-3-methoxybenzyl)amide, 2-hydroxybenzoic acid-N-4-(hydroxy-3-methoxybenzyl)amide, 4-hydroxybenzoic acid-N-(4-hydroxy-3-methoxybenzyl)amide, 2,4-dihydroxybenzoic acid-N-(4-hydroxy-3-methoxy-benzyl)amide monosodium salt, 2,4-dihydroxybenzoic acid-N-2-(4-hydroxy-3-methoxy-phenyl)ethyl amide, 2,4-dihydroxybenzoic acid-N-(4-hydroxy-3-ethoxybenzyl)amide, 2,4-dihydroxybenzoic acid-N-(3,4-dihydroxybenzyl)amide and 2-hydroxy-5-methoxy-N-[2-(4-hydroxy-3-methoxyphenyl)ethyl]amide; 4-hydroxybenzoic acid vanillyl amides (especially as described in WO 2006/024587, which with respect to the corresponding compounds disclosed therein forms part of this application by reference); hydroxydeoxybenzoins, here preferably 2-(4-hydroxy-3-methoxyphenyl)-1-(2,4,6-trihydroxyphenyl)ethanone, 1-(2,4-dihydroxyphenyl)-2-(4-hydroxy-3-methoxyphenyl)-ethanone and 1-(2-hydroxy-4-methoxyphenyI)-2-(4-hydroxy-3-methoxyphenyl)ethanone) (especially as described in WO 2006/106023, which with respect to the corresponding compounds disclosed therein forms part of this application by reference); hydroxyphenylalkanedione, for example gingerdione-[2], gingerdione-[3], gingerdione-[4], dehydrogingerdione-[2], dehydrogingerdione-[3], dehydrogingerdione-[4]) (especially as described in WO 2007/003527, which with respect to the corresponding compounds disclosed therein forms part of this application by reference); diacetyl trimers (especially as described in WO 2006/058893, which with respect to the corresponding compounds disclosed therein forms part of this application by reference); gamma-aminobutyric acids (especially as described in WO 2005/096841, which with respect to the corresponding compounds disclosed therein forms part of this application by reference); divanillins (especially as described in WO 2004/078302, which with respect to the corresponding compounds disclosed therein forms part of this application by reference) and 4-hydroxydihydrochalcones (preferably as described in US 2008/0227867 A1, which with respect to the corresponding compounds disclosed therein forms part of this application by reference), especially phloretin and davidigenin, amino acids or mixtures of whey proteins with lecithins, hesperetin as disclosed in WO 2007/014879, which with respect to these compounds forms part of this application by reference, 4-hydroxydihydrochalcones as disclosed in WO 2007/107596, which with respect to these compounds forms part of this application by reference, or propenylphenyl glycosides (chavicol glycosides) as described in EP 1955601 A1, which with respect to these compounds forms part of this application by reference, or extracts of Rubus suavissimus, extracts of Hydrangea macrophylla as described in EP 2298084 A1, pellitorin and derived flavour compositions as described in EP 2008530 A1, umami compounds as described in WO 2008/046895 A1 and EP 1989944 A1, umami compounds as described in EP 2064959 A1 or EP 2135516 A1, vanillyl lignans, enterodiol, and N-decadienoyl amino acids and mixtures thereof.

Antioxidants

Both natural and artificial antioxidants are used in the food industry. Natural and artificial antioxidants differ primarily in that the former occur naturally in food and the latter are produced artificially. Thus, natural antioxidants, if they are to be used as food additives, are obtained for example from vegetable oils. Vitamin E—also known as tocopherol—is for example often produced from soya oil. Synthetic antioxidants such as propyl gallate, octyl gallate and dodecyl gallate are in contrast obtained by chemical synthesis. The gallates may trigger allergies in sensitive persons. Other antioxidants usable in compositions of the present invention are: sulphur dioxide, E 220 sulphites sodium sulphite, E 221 sodium hydrogen sulphite, E 222 sodium bisulphite, E 223 potassium bisulphite, E 224 calcium sulphite, E 226 calcium hydrogen sulphite, E 227 potassium hydrogen sulphite, E 228 lactic acid, E 270 ascorbic acid, E 300 sodium L-ascorbate, E 301 calcium L-ascorbate, E 302 ascorbic acid ester, E 304 tocopherol, E 306 alpha-tocopherol, E 307 gamma-tocopherol, E 308 delta-tocopherol, E 309 propyl gallate, E 310 octyl gallate, E 311 dodecyl gallate, E 312 isoascorbic acid, E 315 sodium isoascorbate, E 316 tertiary-butylhydroquinone (TBHQ), E 319 butylated hydroxyanisole, E 320 butylated hydroxytoluene, E 321 lecithin, E 322 citric acid, E 330 salts of citric acid (E 331 & E 332) sodium citrate, E 331 potassium citrate, E 332 calcium disodium EDTA, E 385 diphosphates, E 450 disodium diphosphate, E 450a trisodium diphosphate, E 450b tetrasodium diphosphate, E 450c dipotassium diphosphate, E 450d tripotassium diphosphate, E 450e dicalcium diphosphate, E 450f calcium dihydrogen diphosphate, E 450g triphosphates, E 451 pentasodium triphosphate, E 451a pentapotassium triphosphate, E 451b polyphosphate, E 452 sodium polyphosphate, E 452a potassium polyphosphate, E 452b sodium calcium polyphosphate, E 452c calcium polyphosphate, E 452d tin(II) chloride, E 512.

Emulsifiers

Emulsifiers are characteristic for the important property of being soluble both in water and in fat. Emulsifiers generally consist of a fat-soluble part and a water-soluble part. They are always used when water and oil must be made into a stable, homogeneous mixture. Suitable emulsifiers that are used in the food processing industry are selected from: ascorbyl palmitate (E 304) lecithin (E 322) phosphoric acid (E 338) sodium phosphate (E 339) potassium phosphate (E 340) calcium phosphate (E 341) magnesium orthophosphate (E 343) propylene glycol alginate (E 405) polyoxyethylene(8)stearate (E 430) polyoxyethylene stearate (E 431) ammonium phosphatides (E 442) sodium phosphate and potassium phosphate (E 450) sodium salts of edible fatty acids (E 470 a) mono- and diglycerides of edible fatty acids (E 471) acetic acid monoglycerides (E 472 a) lactic acid monoglycerides (E 472 b) citric acid monoglycerides (E 472 c) tartaric acid monoglycerides (E 472 d) diacetyltartaric acid monoglycerides (E 472 e) sugar esters of edible fatty acids (E 473) sugar glycerides (E 474) polyglycerides of edible fatty acids (E 475) polyglycerol-polyricinoleate (E 476) propylene glycol esters of edible fatty acids (E 477) sodium stearoyllactylate (E 481) calcium stearoyl-2-lactylate (E 482) stearyl tartrate (E 483) sorbitan monostearate (E 491) stearic acid (E 570).

The flavourings and colourings and also the further food additives may be present in the protein compositions in amounts of about 0.1 to about 10 wt %, preferably of about 0.5 to about 5 wt % and more particularly of about 1 to about 3 wt %.

### APPARATUS FOR IMPLEMENTING THE PROCESS

The protein compositions of the invention may be produced for example in a sous-vide cooker, in a Thermomix or in a pressure cooker. The process of the invention may be carried out in the same way in this apparatus.

Sous-Vide Cooker

In a first preferred embodiment, step (a) of the present invention is carried out in a sous-vide cooker. This apparatus allows foods to be cooked at relatively low temperatures. Sous-vide cooking, as a variant form of low-temperature cooking, takes place usually in a water bath, owing to the greater heat exchange by comparison with an oven. For the purposes of the present invention, the preparations are welded into a vacuum pouch and then prepared at a constant water temperature in the range from 50 to 85° C. In order to monitor the core temperature of the cooking material, short thermometers (welded in together with the cooking material) or infra-red thermometers are employed here. The vacuum pouches are fabricated customarily from a number of layers of polyamides and polyethylene, in order to prevent extraction of plasticizers from the pouch film into the cooking material. Alternatively there are also built-in steam cooker appliances (combi-steamers) which have a special sous vide programme. In this case, the pouch is placed directly in the steam cooker and the contents are cooked with steam to degree precision. Advantages of sous-vide cooking are that the vacuum-packing means that nothing can escape from the pouch—neither volatile flavours nor flavourings nor else water. Removing the great majority of air within the pouch also reduces oxidation of the cooking material and its flavourings.

Thermomix Appliance

In a further preferred embodiment, step (a) of the present invention is carried out in an appliance called a Thermomix. A Thermomix is a multi-function kitchen appliance from Wuppertaler Unternehmensgruppe Vorwerk, produced in various models since 1961. The Thermomix has twelve functions, and can steam-cook, stir, weigh, mix, grind, knead and comminute. Cooking takes place in a mixing pot made from stainless steel and having a stainless steel knife. The four blades of the knife, in right-hand rotation, comminute the ingredients in stages of up to 10 200 revolutions per minute. In left-hand rotation, foods are mixed and cooked, without being comminuted. The Thermomix is driven in general by a reluctance motor.

More specifically, the Thermomix which can be used to produce the protein composition of the invention is an electrically operated kitchen appliance having a cooking vessel, it being possible for this vessel to be heated directly and/or for the material for cooking within the cooking vessel to be heated indirectly; the preparation of the cooking material takes place, further, by a predetermined exposure to heat for a predetermined time, for the heating and optionally cooking and/or keeping-warm of the cooking material; moreover, especially in the base region of the cooking vessel, there is temperature monitoring provided in relation to a cooking-material temperature, characterized in that the exposure to heat can be monitored in line with measured temperatures of the cooking material, and the time of heat exposure can optionally be adapted in deviation from the predetermined heat exposure time. An apparatus of this kind is the subject, for example, of German Patent Application DE 10 20010 037 769 A1 (VORWERK). The protein compositions of the invention can also be produced by steam cooking in a Thermomix with attachment, by the Varoma process.

Thermomix appliances have the advantage that steps (b) and (c) can be carried out jointly.

Pressure Cooker

In a further preferred embodiment, step (a) of the present invention is carried out in a pressure cooker. The pressure cooker, also called rapid cooker, steam cooker or Papin cooker or Kelomat, is a cookpot in which food can be cooked at temperatures higher than standard boiling temperature (in the case of water, 100° C. at sea level), thereby shortening the cooking time. The increase in the boiling point is made possible by allowing an elevated pressure to build up in the cooker, which has a pressure-tight seal. The pressure cooker is basically a thick-walled cookpot whose opening possesses an edge curved to the outside, with bayonet-like recesses for the pressure-tight accommodation of the lid. The lid has a rubber ring seal and typically both a control valve and a safety valve in order to limit the pressure. Modern rapid cookpots have valves integrated into the lid; on older versions, the valves were screwed in. The control valve generally possesses a pin which rises in response to pressure, with annular markings for pressure display. The valve is nowadays coupled with the lid locking system, allowing the cooker to be opened only when unpressurized, in order to prevent accidents. For the cookers there are perforated and non-perforated inserts for the cooking of meals which, consequently, do not come into contact with the cooking water still in liquid form but are instead cooked in the steam. For the purposes of the present invention, components of these kinds are preferred.

With the pressure cooker, the actual cooking vessel is generally sealed in an air-tight and water-tight manner via a closure mechanism (bayonet closure or pressure closure) with the lid and with a seal. As a result of the consequent steam pressure it is possible to reach a higher temperature than normal for boiling, and thereby to shorten the cooking times. The pressure typically prevailing within the cooker in operation is about 1.8 bar absolute, i.e. 0.8 bar gauge; this is not particularly high, but increases the boiling temperature of the cooking water to about 116° C.

The examples which follow serve to illustrate the invention in more detail without confining it to the content of these examples.

### EXAMPLES

### Example 1

1 kg of commercial skimmed-milk quark was dewatered to constant weight in a rotary evaporator at a temperature of 50° C. and a pressure of 200 mbar for a period of 2 hours; the product from drying had a residual moisture content of 1.7 wt %. 250 g of the product were placed in the mixing bowl of a Thermomix TM31 appliance from Vorwerk, and 20 g of paprika, 2 g of sorbitan monostearate, 2 g of citric acid and 2 g of sodium alginate were added. The appliance was sealed and the comminuting and mixing function was operated for 2 minutes. Then 300 ml of water were added and the mixture was cooked on level 2 at 100° C. for 10 minutes. A composition was obtained that was pale pink in colour, had a fine, slightly curdy cheese texture, and resembled a paprika fresh cheese.

### Example 2

1 kg of commercial skimmed-milk quark was dewatered to constant weight in a rotary evaporator at a temperature of 50° C. and a pressure of 200 mbar for a period of 2 hours; the product from drying had a residual moisture content of 1.7 wt %. 250 g of the product were placed in the mixing bowl of a Thermomix TM31 appliance from Vorwerk, and the content of five commercial 25 g fish flavour packs, 2 g of sorbitan monostearate, 2 g of citric acid, 2 g of pectin and 0.4 g of Brilliant Acid Green. The appliance was sealed and the comminuting and mixing function was operated for 2 minutes. Then 200 ml of water were added and the mixture was cooked on level 2 at 100° C. for 12 minutes. A composition was obtained that was slightly green in colour, had a semi-solid cheese texture, and had a taste resembling that of sushi.

### Example 3

Example 2 was repeated, replacing the quark with an equal amount by weight of soured milk, but the mixture was held in the Thermomix for 15 minutes. A composition was obtained that had a greenish colour, a semi-solid cheese texture, and a taste resembling that of sushi.

### Example 4

500 ml of yoghurt were freeze-dried, and the dry residue, which still had a residual moisture content of 1 wt %, was mixed thoroughly with 40 g of a mixture of dried and finely ground basil leaves and oregano leaves, 2 g of citric acid, 3 g of sodium alginate and 0.3 g of beta-glucan, and repeatedly comminuted. 250 g of this mixture were dispensed into a pouch, vacuum-sealed and introduced into a Steba SV1 sous-vide cooker. The appliance was then set to a temperature of 75° C. and the pouch was left therein for 80 minutes. Obtained after this time was a granular composition reminiscent of fresh cheese, with an intense herb flavour.

### Example 5

500 ml of mild kefir were dewatered to a residual moisture content of 1.7 wt % in a rotary evaporator at 60° C. and a pressure of 100 mbar. 200 g of the dry residue were placed in a 3 l quick cooker from WMF, together with 30 g of ground fenugreek, 10 g of walnuts, 2 g of citric acid and 2 g of pectin, and mixed with 120 g of water. The mixture was then held at 100° C. and 3 bar for 7 minutes. A granular composition was obtained which had an intensely nutty flavour and a distinct cheese texture.

1-13. (canceled)

14. A protein composition for use as cheese substitute, obtainable by
(a) dewatering fermented, sour or acidified milk or corresponding milk products to a residual moisture content of 0.5 to 4 wt. %,
(b) adding flavourings and/or colourings and also, optionally, further food additives to the dried composition thus obtained, and
(c) allowing the resulting mixture to swell with water or steam

15. The composition of claim 14, wherein the fermented, sour or acidified milk or the corresponding milk products are selected from the group consisting of soured milk, fermented milk, yoghurt, kefir, quark, acid whey and mixtures thereof.

16. The composition of claim 14, wherein the further food additives are selected from the group consisting of sweeteners, food acids, acidity regulators, thickeners, prebiotics, probiotics, flavour enhancers, flavour-masking agents, antioxidants and mixtures thereof.

17. The composition of claim 14, wherein the flavourings and colourings and also, optionally, the further additives are present in amounts of 0.1 to 10 wt. %.

18. A process for producing a protein composition with cheese texture, comprising the following steps:
(a) dewatering fermented, sour or acidified milk or corresponding milk products to a residual moisture content of 0.5 to 4 wt. %,
(b) adding flavourings and/or colouring and also, optionally, urther food additives to the dried composition thus obtained, and
(c) allowing the resulting mixture to swell with water or steam, wherein step (c) takes place at temperatures in the range from 50 to 150° C.

19. The process of claim 18, wherein the starting materials are subjected to vacuum drying, spray drying or freeze drying.

20. The process of claim 18, wherein the dewatering is carried out to a residual moisture content of 1 to 3 wt. %.

21. The process of claim 18, wherein step c takes place at a pressure in the range from 0.1 to 1 bar.

22. The process of claim 18, wherein step (c) takes place at a pressure in the range from 1 to 5 bar.

23. The process of claim 18, wherein step (a) is carried out in a sous-vide cooker.

24. The process of claim 18, wherein step (a) is carried out in a Thermomix appliance.

25. The process claim 18, wherein step (a) is carried out in a pressure cooker.

26. The process of claim 18, wherein steps (b) and (c) are carried out together in a Thermomix appliance.
